(19) United States
(12) Patent Application Publication
(10) Pub. No.: US 2012/0215327 A1
(43) Pub. Date: Aug. 23, 2012

(54) NETWORKED GAMING SYSTEM AND METHOD FOR TRACKING COMMUNITY ACTIVITIES

(75) Inventor: Charles Wright, JR., Seattle, WA (US)

(73) Assignee: SEMS, LLC, SEATTLE, WA (US)

(21) Appl. No.: 13/214,189

(22) Filed: Aug. 20, 2011

Related U.S. Application Data
(60) Provisional application No. 61/375,710, filed on Aug. 20, 2010.

(51) Int. Cl. G06F 19/00

(52) U.S. Cl. 700/91

(57) ABSTRACT

System and method for tracking player community activities that support student success. The method enables players to select community activities that the player has performed, calculates a total numerical value for the player and determines an award for players.

### CLAIM OF PRIORITY

The present invention claims priority form U.S. Provisional Application No.: 61,375,710, entitled Networked Gaming System and Method, filed Aug. 20, 2010, the specification of which is hereby incorporated by reference as if fully set forth in the present application.

### CROSS REFERENCE TO RELATED APPLICATIONS

The present application is related to U.S. patent application Ser. No. 12/496,645, entitled EDUCATION INFORMATION AND FUNDING READINESS SCORE SYSTEM AND METHOD (Attorney Docket No CWRIGHT.001US) and U.S. patent application Ser. No. 12/496,647, entitled USER INTERFACE FOR EDUCATIONAL INFORMATION FOR COMPUTER NETWORKS (Attorney Docket No CWRIGHT.002US) both of which were filed on Jul. 2, 2009, the applications of which are hereby incorporated by reference as if fully set forth in the present application.

### BACKGROUND OF THE INVENTION

The present invention relates generally to community support gaming systems and methods and more specifically to community support gaming systems and methods for playing games that support community success.

Many individuals are known to provide their support particularly for community education initiatives. Parents are known to contribute to community education initiatives as volunteers, mentors, donors, promoters, and as parents of participants in these initiatives. Extended family members might also contribute to these community education initiatives in the same manner as parents.

Corporations, public institutions and service organizations might also form strategic partnerships to enhance community initiatives leveraging their financial resources, relationships, facilities, as well as staff time and expertise. Professionals also do the same as public institutions one their own accord.

While many such individuals and entities obtain the satisfaction of being altruistic, there does not appear to be a fun, easy way to engage students, parents, extended families, professionals, and institutions in supporting key behaviors that support student development, adult engagement, and an active lifestyle.

There is a need to address one or more of the aforementioned problems and the present invention meets this need.

### BRIEF SUMMARY OF THE INVENTION

Various aspects of a method for tracking player activities including educational activities that support local communities can be found in exemplary embodiments of the present invention.

In one embodiment, the method employs a networked computer system having a processing platform including memory, a processor and a user interface. Upon a player creating a profile, the method permits the player to select community activities performed by the player for tracking.

Here, community activities might include sharing resources, certain type of actions that engage other community members, etc. Multiple players can create their own profiles and competitively track their community activities.

In one embodiment, community activities are categorized into levels of skill or engagement so that each level can then be selected by the player. In an alternate embodiment, engagement levels are not selectable and players might simply begin at the lowest level of engagement.

The method of the present invention also permits calculation of a total numerical value based upon values of the community activities performed by the player for a specific level of engagement, after which an award that is based upon the numerical value is awarded. An advantage is that the present invention provides a fun, easy way to engage students, parents, extended families, professionals, and institutions in supporting key behaviors that support student development, adult engagement, and an active lifestyle.

A further understanding of the nature and advantages of the present invention herein may be realized by reference to the remaining portions of the specification and the attached drawings. Further features and advantages of the present invention, as well as the structure and operation of various embodiments of the present invention, are described in detail below with respect to the accompanying drawings. In the drawings, the same reference numbers indicate identical or functionally similar elements.

### BRIEF DESCRIPTION OF THE DRAWINGS

FIG. 1A shows a community support gaming system according to an exemplary embodiment of the present invention.

FIG. 1B shows a typical computer such as would be operated by a player on the Internet for this invention.

FIG. 1C shows subsystems of the computer of FIG. 1B.

FIG. 2 shows a screenshot for a display output for a community success application (app) according to an exemplary embodiment of the present invention.

FIG. 3 is a screenshot for a display generated when the junior engagement level of FIG. 2 is selected according to an exemplary embodiment of the present invention.

FIG. 4 shows a screenshot for a display generated when the animator distinction title of FIG. 3 is selected according to an exemplary embodiment of the present invention.

FIG. 5 shows a screenshot for a display generated when the share activity category of FIG. 4 is selected according to an exemplary embodiment of the present invention.

FIG. 6 shows a screen shot of a display depicting an award of a title of distinction according to an exemplary embodiment of the present invention.

### DETAILED DESCRIPTION OF THE INVENTION

Reference will now be made in detail to the embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, numerous specific details are set forth in order to provide a thorough understanding. However, it will be obvious to one of ordinary skill in the art that the present invention may be practiced without these specific details. In other instances, well known aspects have not been described in detail as not to obscure aspects of the present invention.

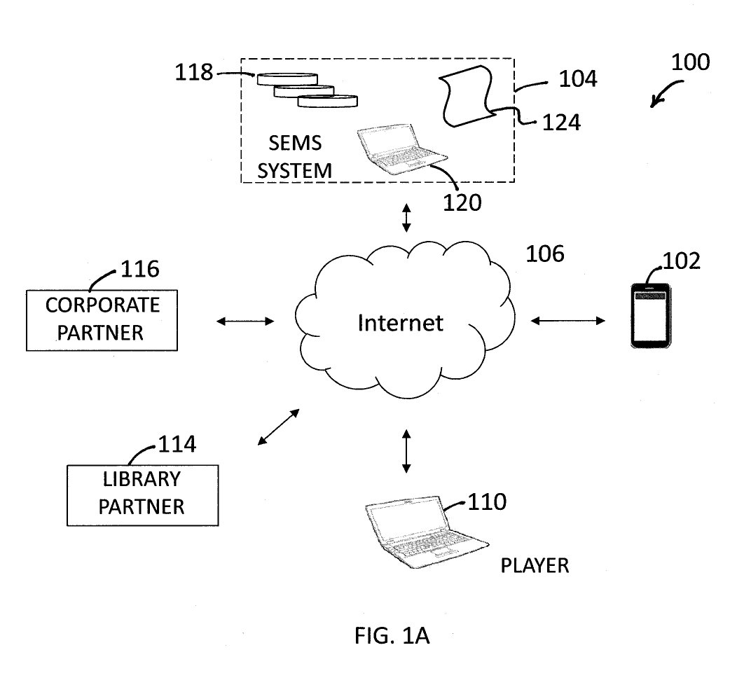

FIG. 1A shows community support gaming system 100 according to an exemplary embodiment of the present invention.

In FIG. 1A, among other components, community support gaming system 100 comprises a user or player 102 communicably linked to SEMS (School Evaluation and Management Services) System 104 via Internet 106. Although not shown, Internet 106 represents any distributed network (wireless, wired, e.g., RS232) for data transmission and receipt between two points. The system of the present invention can work effectively with any possible distribution of interconnected processors regardless of the specific topology, hardware and protocols used.

Here, player 102 represents a community member that is interested in supporting the community. Player 102 might be particularly interested in supporting student success by being a mentor, volunteering time, providing monetary donations or other like resources consistent with the principles and scope of the present invention as further described below.

Player 102 might be a director of young people nurturing club (e.g. Boys and Girls club) that is seeking to earn prizes on behalf of the club. Player 102 might also be a parent seeking to enrich school programs for their children. In fact, player 102 can also be a student or other community members seeking to volunteer their time and resources.

Although not discussed, player 102 can be involved in numerous community activities, some of which involve online interaction with SEMS System 104 while others involve offline interactions with community members. Community activities are pertinent to the present invention so long as such community activities can be reasonably said to contribute to the success of the community student or youth. Note that community activities extend more than volunteer activities and might include activities that involve behaviors that support student development and adult engagement.

As illustrated in FIG. 1A, player 102 utilizes a wireless device such as a smartphone preferably with a geo-location feature to interact with SEMS System 104. Such interaction might occur via an associated website served up by SEMS System 104 (not shown). Any wireless device running a conventional operating system such as Google Android, Apple iOS, Palm Web, Nokia Sybian, etc. and the like might be utilized.

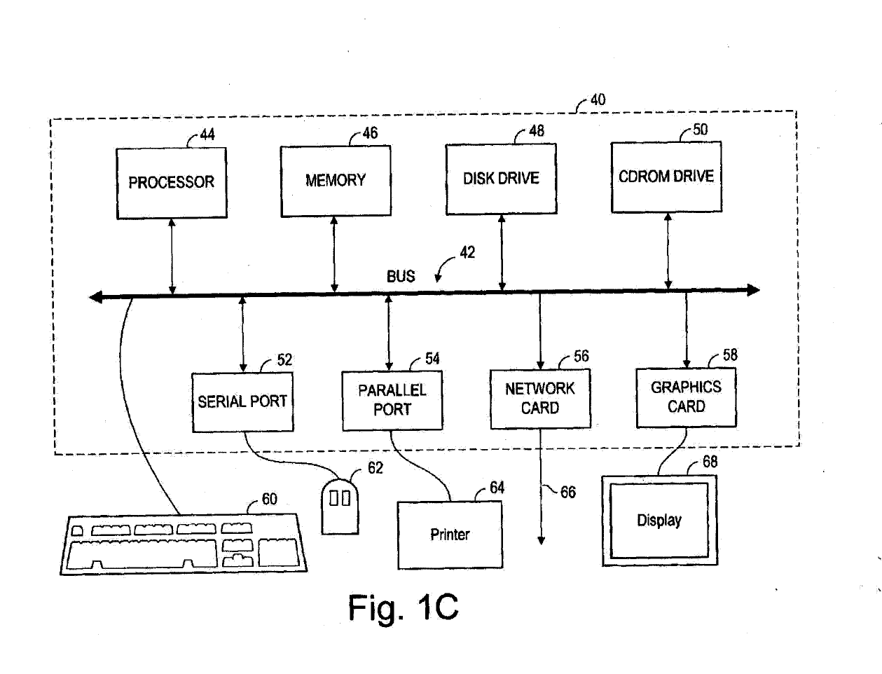

In an alternate embodiment, interaction might be via a voice communication system such as telephones and the like. Further yet, a community gaming application (app) can be executed to run on the wireless device without reference to SEMS System 104 as further discussed with reference to FIGS. 3-6.

Here, player 102 can provide data pertinent to activities performed to SEMS System 104; SEMS System 104 can in turn track and store the data for use with community support gaming system 100. No known convention system is known to perform tracking and gaming in accordance with the principles and precepts of the present invention as further described below.

In FIG. 1A, community support gaming system 100 also includes player 110 that is communicably coupled to SEMS System 104. Here, player 110 and player 102 are similar in that students, parents, extended families, professionals and the like can support key behaviors that support student development, adult engagement, and an active lifestyle. Player 110 and player 102 can compete with each other to determine which player can obtain a winning score as well as awards associated with said winning score.

Unlike player 102, player 110 interacts with SEMS System 104 via a computing device. This computing device itself can be of varying types including laptop, notebook, palm-top, pen-top, etc., and may not resemble the computer of FIG. 1A as in the case where a processor is embedded into another device or appliance such as an automobile or a cellular telephone. Because of the ever-changing nature of computers and networks, the description of hardware in this specification is intended only by way of example for the purpose of illustrating the embodiment.

In FIG. 1A, a further component of community support gaming system 100 is library partner 114. As shown, library partner 114 is also communicably coupled to SEMS System 104 via Internet 106. Although shown as being communicably coupled, library 114 and SEMS System 104 need not be connected to each other.

Here, library partner 114 might represent a local library that is a strategic partner of SEMS System 104. The local library might provide dedicated times and books for specific student groups. Players 102 and 110 can also volunteer their time at this local library while SEMS System 104 tracks all of the volunteered time.

When player 102 is at a partner location site, the geo-location feature of player 102 can be used to track community activities performed by player 102. When player 102 sends community activity data to SEMS System 104, player 102 transmits an activity code from the partner location.

SEMS System 104 uses the geo-location feature to check that the activity code was received from the partner location. In this manner, the system can track the legitimacy of hours performed for community activities. Note also that partner staff may also submit verification information on behalf of player 102 to SEMS System 104.

In FIG. 1A, community support gaming system 100 further comprises corporate partner 116. Corporate partner 116 might be a small business or fortune 500 company that provides prizes and monetary rewards to winning players. Although only library 114 and corporate partner 116 are illustrated as strategic partners, one skilled in the art will realize that other comparable institutions can be integrated into the present invention in accordance with the principles and precepts of the present invention.

In FIG. 1A, the components of SEMS System 104 for tracking player activities that support local communities are illustrated. Specifically, SEMS System 104 comprises SEMS database system 118. Users can access SEMS database system 118 via a proprietary website (not shown) associated with the present invention.

This website might be hosted by dedicated server 120 serving up web page 122. SEMS database system 118 includes a content management system and repository for data. SEMS database system 118 may also include both relational and object XML data stores (not shown). SEMS database system 118 can provide for storage, viewing, importing, organizing, modifying, exporting, and query of education related information.

In operation, player 102 (and player 110) begins by creating a profile with SEMS System 104. More specifically, player 102 uses web page 122 to log onto a website served up by dedicated server 120. Here, player 102 provides personal and user preference information into various data entry forms presented by dedicated server 120. The collected information is saved and used to create user profile. A unique ID/Password associated with the user profile can then be employed by player 102 for future storage of retrieval of educational information.

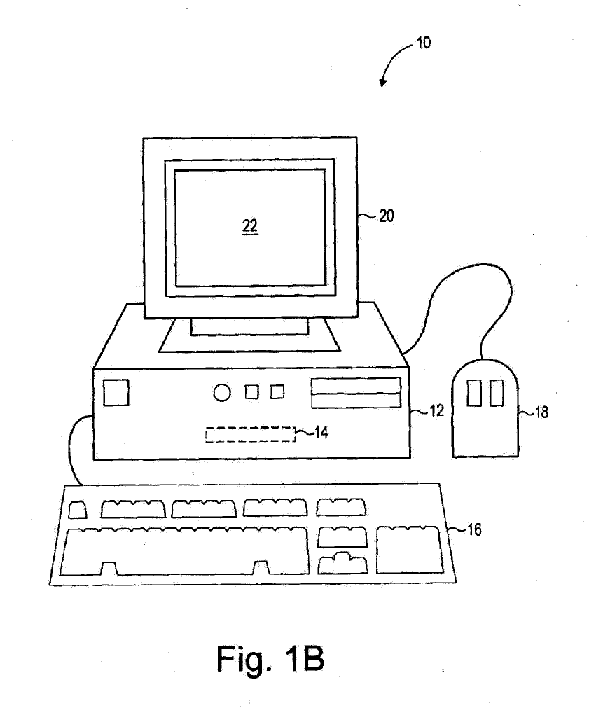

Here, player 102 might be a director of young people nurturing club, for example. The director might be trying to win awards for the club. The director might also try to motivate/inspire others to get involved in their programs personally or to send their children to the programs. After logging onto SEMS System 104, a home web page 200 (FIG. 2) is served up. Player 102 can navigate the website to play a game by entering community activities performed to encourage student success.

Similarly, player 110 can enter community activity data and compete against player 102 to determine which player can win the most awards. The system can display total community hours performed by player 102 and player 110. Players then compete against each other to see who can generate the most points and awards. Players can also join multiple groups and compete against the individuals in those groups. This gaming system then provides a fun way in which to encourage behavior that contributes to community success. The more community activities entered, the more awards can be won by players.

Among other awards, players can win recognition, prizes, monetary equivalent awards based on the numeric value of community activities performed. No conventional community support gaming system or method is known to provide gaming to earn points and awards to support community and student success in particular.

FIG. 2 shows screenshot 200 of community success app 202 according to an exemplary embodiment of the present invention.

In FIG. 2, player 102 can run community success app 202 on a mobile device platform to play a community game. This community game can foster success and nurture the development of young people within a local community.

Community success app 202 is preferably based on an Apple iOS platform code adapted to run natively on iPhone and iPad mobile environments. iOS also includes iOS SDK (Software Development Kit) containing code, information, and tools needed to develop and run applications for iOS. It is intended that the description, operation and use described in the referenced specification be utilized to implement community success app 202. One skilled in the art will realize that other comparable development platforms can be utilized.

Initially, player 102 begins by downloading community success app 202 from SEMS System 104. Specifically, player 102 creates and stores a profile on SEMS System 104. The profile might include a name, age, address, job, volunteer experience and other pertinent ability or skill level information.

Thereafter, player 102 can then downloads and initiate community success app 102. Upon initiation, community access app 202 displays three levels of engagement that player 102 can participate in. These engagement levels are JUNIOR engagement level 204, INTERMEDIATE engagement level 206 and MASTER engagement level 208.

In one embodiment, each engagement level is distinguished by the number of points one must obtain before progressing to the next level. For example, JUNIOR engagement level 204 might require 30,000 points. INTERMEDIATE engagement level 206 might require 60,000 points while MASTER engagement level 208 requires 100,000 points.

Only upon completion of JUNIOR engagement level 204 can player 102 proceed to INTERMEDIATE engagement level 206. All of the points accumulated at JUNIOR engagement level 204 are then applied to INTERMEDIATE engagement level 206. Thus, if player 102 has completed JUNIOR engagement level 204, player 102 requires only 30,000 points to complete INTERMEDIATE engagement level 206.

Similarly, only upon completion of INTERMEDIATE engagement level 206 can player 102 proceed to MASTER engagement level 208. All of the points accumulated at INTERMEDIATE engagement level 206 are then applied to MASTER engagement level 208. Thus, if player 102 has completed INTERMEDIATE engagement level 206, player 102 requires only 40,000 points for a total of 100,000 points to complete MASTER engagement level 208.

In another embodiment, the engagement levels are distinguished by age. Thus, JUNIOR engagement level 204 might comprise players ages 8-18. INTERMEDIATE engagement level 206 might be comprised of players ages 19-39. MASTER engagement level 208 may comprise players ages 39 and over.

In a further embodiment, the engagement levels may be characterized by skill or experience level. For example, JUNIOR engagement level 204 may comprise players with little or no experience (e.g., in a particular aspect of community service). INTERMEDIATE engagement level 206 might be for medium skilled players and MASTER engagement level 208 for highly skilled players.

In any event, note that the engagement levels may either be selectable or non-selectable. If non-selectable, all players are required to begin from the lowest level i.e. JUNIOR engagement level 204. If selectable, players such as player 102 can proceed as illustrated in FIG. 3.

Note here that references to player 102 are also applicable to player 110. Both players can play independently or compete against each other. Scores can be uploaded to SEMS System 104 by community service app 202. SEMS System 104 can display community activity scores for all players as players progress.

FIG. 3 is a screenshot of display 300 that is output when JUNIOR engagement level 204 of FIG. 2 is selected.

In FIG. 3, player 102 can use display 300 to select any one of three titles of distinction for the junior engagement level. The selectable titles of distinction are Animator 304, Champion 306 and Resource 308. As players earn points, they can earn one or more titles of distinctions.

Animator titles of distinction recognize players that can impart energy and vitality and spirit to other people. Champion titles recognize players that can fight for a cause. Resource titles identify players that are valuable aid resources and can be relied upon as supportive individuals.

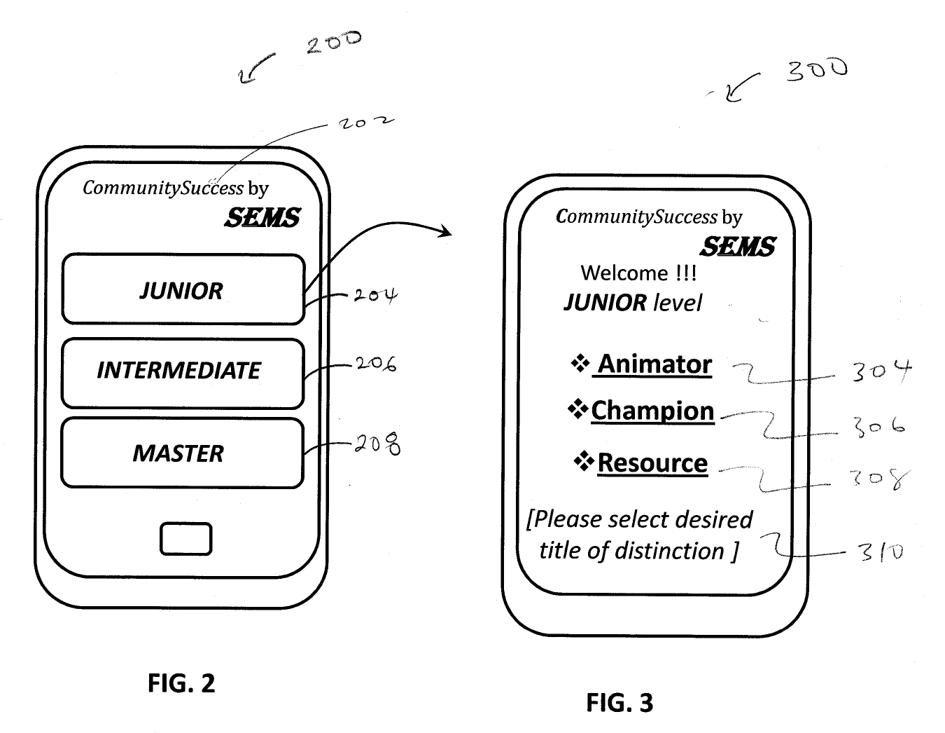

Referring now to FIG. 3, display 300 also includes a “please select title desired of distinction” 310 directing players to select their preferred title of distinction. Once selected, the appropriate interface for the selected title of distinction is displayed as illustrated in FIG. 4 below.

FIG. 4 shows a screenshot for display 400 generated when Animator 304 distinction title of FIG. 3 is selected in accordance with an exemplary embodiment of the present invention.

In FIG. 4, display 400 is such that player 102 can see the total number of points required for completion. Here, the total number of points required for completion as indicated at 401 is 30,000 points.

Here, as shown, player 102 can utilize display 400 to select one of four activity categories in which player 102 is involved. These activity categories are Share 402, Refer 404, Dialogue 406 and Action 408 activity categories.

Each activity category is determined based on leading player attributes. Share 402 focuses on sharing information the website served up by SEMS System 104 with people in within the network of player 102, sharing things about oneself, and sharing information on the website.

Refer 404 activity category focuses on referring information (articles, programs, services, discounts, etc.) to someone else. Dialogue 406 activity category focuses on communicating player 102's thoughts on a comment, article and experience to someone else. Although not shown, selectable buttons that allow users to recognize contributors for attributes such as influence, courage (willingness to be contrarian) and relevance are provided. Points might be awarded for such contributions.

Action 408 activity category focuses on player 102 doing things in the community that support young people. Although not discussed, one skilled in the art will realize that other related activities might be utilized.

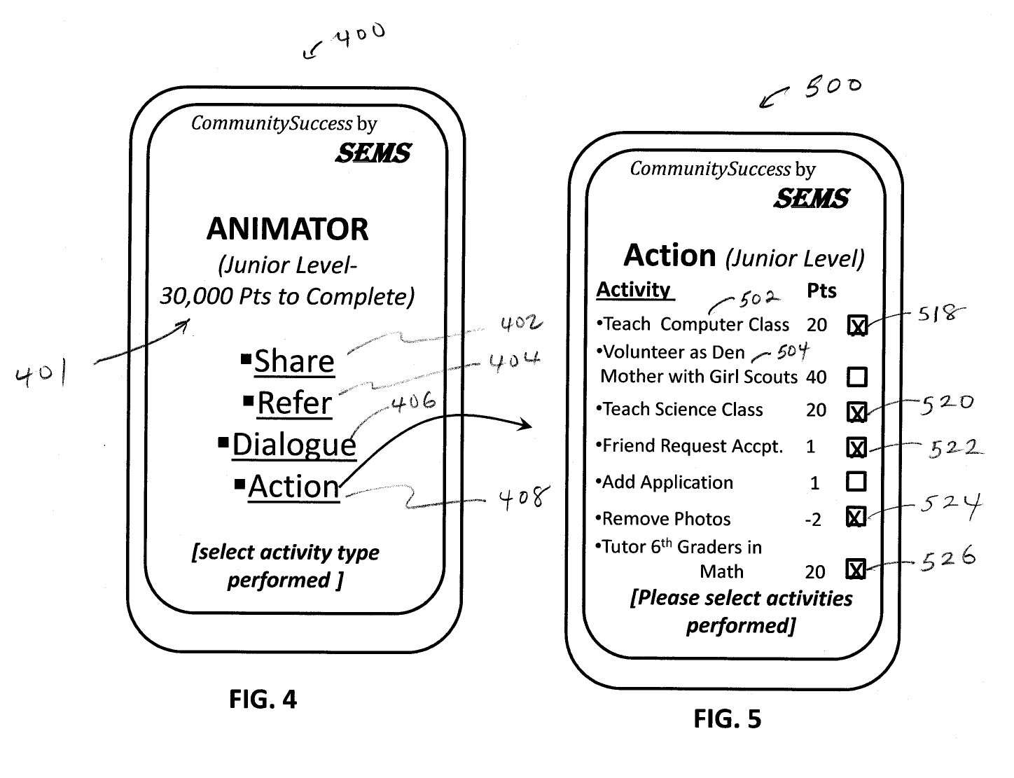

FIG. 5 shows a screenshot for display 500 generated when Action 408 activity category of FIG. 4 is selected.

In FIG. 5, player 102 can employ display 500 to select which share activities are performed to support community success. By so doing, player 102 can also utilize the system to determine a total numeric value based upon the community activities performed by player 102.

In one embodiment, the numeric value is based on a predetermined point system in which predetermined points are assigned to share activities. By predetermined, it is meant that a specific amount of point is assigned (and stored) beforehand to each point activity. The points are assigned before players actually initiate community success app 202.

In FIG. 5, various share activities are displayed including Teach Computer Class 502, which is assigned 20 points, Volunteer as Den Mother with Girl Scouts 504, which is assigned 40 points, etc. Here, note that player 102 can page down to access additional shared activity not currently illustrated in FIG. 5.

Not only can pre-assigned points be added toward a total numeric value, points may also be deducted for activity considered contrary to community success. Thus, as shown, Remove Photos 516 can cause player 102 to lose points for removing photos from the system website. Note that point value assigned to a particular activity is based on the difficulty level (effort and time) and relative impact (compared to other items that are being scored) of that the activity has to inspire others.

In FIG. 5, player 102 checks box 518, box 520, box 522 and 526 to indicate activities performed. Box 524 is automatically checked once player 102 is authenticated. Upon checking all of the requisite check boxes, player 102 then selects a submit button (not shown).

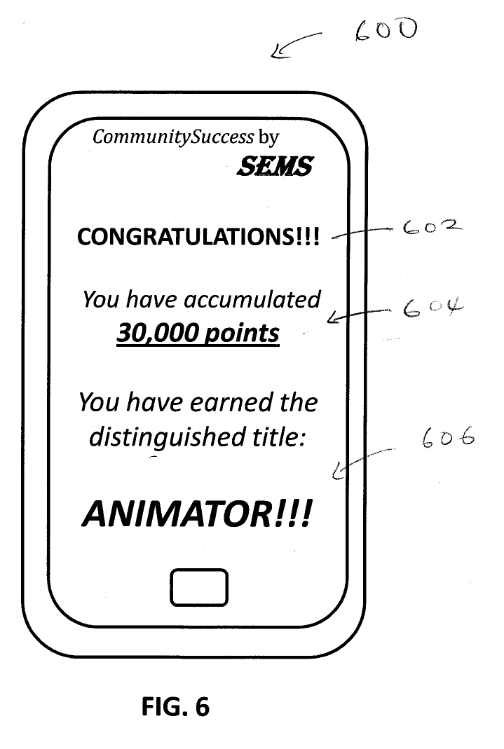

Community success app 202 then calculates a total numerical value based upon values of the community activities checked. Here, the numerical value calculated for player 102 is 20+20+1−2+20=59. The more activities performed, the higher the numeric value of the player 102. Once 30,000 points is reached, player 102 is awarded an appropriate title of recognition as discussed with reference to FIG. 6.

FIG. 6 shows a screen shot of display 600 depicting award of a title of distinction.

In FIG. 6, display 600 shows a congratulatory message to player 102 at 602. Here, player 102 has accumulated 30,000 points as shown by message 604. Player 102 has been awarded a distinguished recognition title of ANIMATOR as shown at 606. Note here that although the award is a title of recognition, the award may be monetary equivalents, prizes or other benefits whether or not donated by a strategic partner organization such as a fortune 500 corporation. Awards may be other forms of social recognition, i.e., dinner with mayor, superintendent, name in the paper, recognition at community event, etc.

Additional Example: Junior Engagement Level—Monthly Level for Titles of Distinction

| Title of | | | | | |
|---|---|---|---|---|---|
| Distinction | Share | Refer | Dialogue | Action | Total |
| Animator | 5000 | 5000 | 10,000 | 10000 | 30,000 |
| Champion | 5000 | 7500 | 10000 | 7500 | 30,000 |
| Resource | 5000 | 10000 | 7500 | 5000 | 30,000 |

Each title of distinction can have activities that fall in the four or more categories that are tagged as leading attributes. If a player scores points in that category, the player can progress towards achieving the distinction. Numerical value totals can be set periodically by title weekly, monthly, quarterly and/or yearly.

Additional Examples of Activities for Activity Categories

| Share | Refer | Dialogue | Action |
|---|---|---|---|
| Initiate Sharing | Refer an activity | Start group | Register for an |
| Post resources | Endorse an opportunity | Initiate | activity on site |
| Endorsements | (1st 50% of community) | discussion | Get Mentee/ |
| Rating of res. | Endorse an opportunity | Reply to | Length of time |
| Fwd a share | (51%-75% of | discussion | Lead Course |
| Upload photos | community) | question | Participate in |
| Update profile | Endorse an opportunity | Size of the | program |
| Update status | (76%-95% of | group | Connect w/ in- |
| New photo | community) | Friends | network |
| album | Referral joins activity | approval | mentee |
| Publications | Refer to individual | Blog post | Connect w/ in- |
| distribution | w/ low participation | Blog reply | network |
| Post an activity | Low Part. Referee joins | Comment on | mentor |
| Link AAMS | Referrer of New | article | Donate |
| to site | members | | Sponsorships/ |
| (approp) | Referrer of New | | Scholarships |
| | employee | | |

Additional Examples of Activities, Points and Assigned Categories

| Activity | Points | Category |
|---|---|---|
| Comment, photos, or video gets reported and | −25 | Share |
| taken down due to abuse | | |
| Remove Photos | −2 | |
| Leaving Group | −2 | |
| Remove Photos | −2 | |
| Remove Album | −2 | |
| Remove Wall | −2 | |
| Delete News | −2 | |
| Remove Group Member | −2 | |
| Remove Application | −1 | |
| Comment or activity liked | 1 | Dialogue |
| Send friend request | 1 | Share |
| Friend request accepted | 1 | Share |
| Profile Status Update | 1 | Share |
| Update Avatar | 1 | Share |
| Upload Group Avatar | 1 | Share |
| Add Application | 1 | Share |
| Update Privacy Settings | 1 | |
| Post to Group Wall | 2 | Dialogue |
| Send Message | 2 | Dialogue |
| Join Group | 2 | Share |
| Add New Photo or video | 2 | Share |
| Accept Friend Request | 2 | Share |
| Fwd a share | 2 | Share |
| Comment on article, photo, video, or activity | 3 | Dialogue |
| Reply Message | 3 | Dialogue |
| Reply Group Discussion | 3 | Dialogue |
| Like or dislike an activity | 3 | Dialogue |
| Accept volunteer invitation | 5 | Action |
| Create new group discussions | 5 | Dialogue |
| Share activities in activity finder, reading room, | 5 | Refer |
| or volunteer finder | | |
| Create Group News | 5 | Share |
| Submit Article to Reading Room | 5 | Share |
| Article submitted to Reading Room gets posted | 5 | Share |
| Use the share link | 5 | Share |
| Link AAMS to appropriate sites | 5 | Share |
| Provide feedback to help improve All About My | 10 | Dialogue |
| School Site | | |
| Report abuse | 10 | Dialogue |
| Submit Activity to Activity Finder or Site Based | 10 | Share |
| Management | | |
| Post Volunteer Activity to Volunteer Finder | 10 | Share |
| Refer to individual w/ low participation | 10 | Share |
| Referral joins activity | 25 | Action |
| Register for an activity on site | 25 | Action |
| Get Mentee/ | 25 | Action |
| Connect w/ in-network mentee | 25 | Action |
| Connect w/ in-network mentor | 25 | Action |
| Low Part. Referee joins | 50 | Action |
| Participate in program | 50 | Action |
| Donate | 50 | Action |
| Sponsorships | 50 | Action |
| Scholarships | 50 | Action |
| Lead Course | 75 | Action |
| Referee of New Members | | Action |
| Size of the group on blogs, likes of comments | | Dialogue |
| Referrer of New Employee | | Share |

Examples of Levels Players can Achieve Before they Reach the Master Distinction of Resource, Animator, or Champion.

Animator
Player
Associate
Warrior
Influencer/Leader
Powerhouse/Animator
Champion
Player
Supporter/Advocate
Spokesperson
Hero
Resource
Player
Aid
Facilitator
Connector
Resource

FIG. 1B shows a typical computer 10 such as would be operated by a user on the Internet for this invention. Computer 10 includes a cabinet 12 housing familiar computer components such as a processor, memory, disk drive, Compact Digital Read Only Memory (CDROM), etc. (not shown). User input devices include keyboard 16 and mouse 18. Output devices include display 20 having a display screen 22. Naturally, many other configurations of a computer system are possible.

Some computer systems may have additional components to those shown in FIG. 1B while others will have fewer components. For example, server computers need not have attached input and output devices since they may only be accessed from time to time by other computers over a network. Human interaction with such a server computer can be at another computer that is equipped with input and output devices. Input and output devices exist in many variations from those shown in FIG. 1B.

Displays can be liquid crystal displays (LCD), computer monitors, plasma, etc. Input devices can include a trackball, digitizing tablet, microphone, etc. In general, use of the term “input device” is intended to include all possible types of devices and ways to input information into a computer system or onto a network. Likewise the term “output device” includes all possible types of devices and ways to output information from a computer system to a human or to another machine. Any distributed networked system capable of executing programmed instructions is suitable for use with the present invention.

FIG. 1C shows subsystems of the computer of FIG. 1B. In FIG. 1C, subsystems within box 40 are internal to, for example, the cabinet 12 of FIG. 1B. Bus 42 is used to transfer information in the form of digital data between processor 44, memory 46, disk drive 48, CDROM drive 50, serial port 52, parallel port 54, network card 56 and graphics card 58. Many other subsystems may be included in an arbitrary computer system and some of the subsystems shown in FIG. 1C may be omitted.

External devices can connect to the computer system's bus (or another bus or line, not shown) to exchange information with the subsystems in box 40. For example, devices such as keyboard 60 can communicate with processor 44 via dedicated ports and drivers (shown symbolically as a direct connection to bus 42). Mouse 62 is connected to serial port 52. Devices such as printer 64 can connect through parallel port 54. Network card 56 can connect the computer system to a network. Display 68 is updated via graphics card 58. Again, many configurations of subsystems and external devices are possible.

While the above is a complete description of exemplary specific embodiments of the invention, additional embodiments are also possible. Thus, the above description should not be taken as limiting the scope of the invention, which is defined by the appended claims along with their full scope of equivalents.

I claim:

1. In a computer system having a processing platform including memory, a processor, and a user interface, a method for tracking player activities including educational activities that support local communities, said method comprising:
allowing a player to select one or more community activities that the player has performed to support student success, wherein said community activities are categorized into two or more levels of engagement, each level of engagement being selectable by said player;
calculating a total numerical value based upon values of the community activities performed by the player for a selected level of attainment; and
determining an award for said player based on the numerical value of the selected level of attainment.

2. The method of claim 1 wherein each level of engagement is associated with a predetermined amount of points.

3. The method of claim 1 wherein said values of community activities are predetermined.

4. The method of claim 1 wherein said values of community activities are predetermined point values.

5. The method of claim 1 wherein the award is a title of recognition.

6. The method of claim 1 wherein said award is a predetermined prize.

7. The method of claim 1 wherein said award is monetary equivalents.

8. In a computer system having a processing platform including memory, a processor, and a user interface, a method comprising:
allowing a player to select one or more community activities that the player has performed to support community success, wherein said community activities are categorized into two or more levels of engagement;
determining a total numerical value based upon values of the community activities performed by the player for a level of engagement; and
determining an award for said player based on the numerical value of the level of engagement.

9. The method of claim 8 wherein each level of engagement is associated with a predetermined amount of points.

10. The method of claim 8 wherein said values of community activities are predetermined point values.

11. In a computer system having a processing platform including memory, a processor, and a user interface, a system comprising:
one or more lines of software code for allowing a player to select one or more community activities that the player has performed to community success, wherein said community activities are categorized into two or more levels of engagement;
one or more lines of software code for determining a total numerical value based upon values of the community activities performed by the player for a level of engagement; and
one or more lines of software code for determining an award for said player based on the numerical value of the level of engagement.

12. The system of claim 11 wherein each level of engagement is based on an amount of points required for each level.

13. The system of claim 11 wherein said values of community activities are predetermined point value.

14. The system of claim 11 further comprising one or more lines of software code for categorizing said community activities by attributes of said community activities.

15. In a computer system having a processing platform including memory, a processor, and a user interface, a method comprising:
permitting a player to select one or more community activities that the player has performed to support community success;
determining a total numerical value based upon values of the community activities performed by the player; and
determining an award for said player based on the total numerical value based upon the community activities performed by the player.

16. The method of claim 15 wherein said values of community activities are predetermined point values.
